(19) United States
(12) Patent Application Publication
(10) Pub. No.: US 2018/0230048 A1
(43) Pub. Date: Aug. 16, 2018

(54) SURFACE-MODIFIED GLASS FIBER WITH BI-COMPONENT CORE-SHEATH STRUCTURE

(71) Applicant: ISOLITE GmbH, Ludwigshafen (DE)

(72) Inventors: Michael Knoll, Birkenau (DE); Davide Pico, Aachen (DE)

(21) Appl. No.: 15/896,175

(22) Filed: Feb. 14, 2018

(30) Foreign Application Priority Data
Feb. 16, 2017 (EP) 17156526.0

(51) Int. Cl. C03C 25/40; C03B 37/01; C03C 13/00; C03B 37/07; C08J 7/14

(52) U.S. Cl. CPC C03C 25/40; C03B 37/01; C03B 2203/02; C03B 37/07; C08J 7/14; C03C 13/00

(57) ABSTRACT

Surface-modified glass fiber, comprising: a core made of a first glass fiber material; a surface layer that encloses the core completely in a sheath-like way; wherein the surface layer has a higher silicon dioxide percentage and a higher porosity compared to the core.

### BACKGROUND OF THE INVENTION

### Field of the Invention

The invention relates to a surface-modified glass fiber with a bi-component core-sheath structure as well as a method for producing a fiber of this type.

### State of the art

Different fiber types are known in the field of acoustic and thermal insulation. Some examples are explained in the following.

### Glass Fibers

Glass fibers are inorganic fibers with an amorphous structure and without molecular orientation. Due to their structure, they have isotropic properties. Due to the covalent bond between silicon and oxygen, they have a high firmness. Depending on their composition, glass fibers are classified into different types. For example, E-glass, R-glass, S-2-glass, C-glass, D-glass and AR-glass, to mention a few. Each of these glass types is characterized by special features. E-glass fibers are typically the most inexpensive fiber types and also the most widespread glass fiber type with a market share of approximately 90%. The annual global production amounts to approx. 5,000,000 t. The tensile strength of a glass fiber is approx. 3.4 GPa and the elasticity module, i.e. e-module, amounts to approx. 75 GPa.

### Silicate Fibers

Silicate fibers are amorphous fibers. They mainly consist of silicon dioxide, SiO₂. They are produced by means of two different processes (sol-gel dry method or leaching); the sol-gel method is a dry-spinning process in which fibers are spun directly in filaments of a gel and dried. The gel is mostly obtained through polymerization of organosilanes (e.g. TEOS). Silicate fibers are obtained through leaching methods out of glass fiber precursors. The SiO₂ percentage will increase from 52% and 70% of the glass fiber precursors to more than 93% at the end of the process due to leaching of the other oxides of the glass. They are offered on the market with a diversity of features. The most affordable fibers have a price of less than 10€/kg. Silicate fibers have a very low firmness and are used in temperature ranges up to a maximum of 1000° C. Silicate fibers have a higher SiO₂ content than glass fibers and an amorphous structure. They consist at least of 93% of SiO₂ and therefore have a higher thermal stability of up to 1,050° C. Compared to other fibers such as ceramic fibers, basalt fibers, quartz fibers, glass fibers and other inorganic fibers, silicate fibers have a lower tensile strength with approx. 0.35 GPa.

### Ceramic Fibers

Ceramic fibers are fibers made of polycrystalline, inorganic materials. Their thermal stability reaches up to 1600° C. Ceramic fibers are divided into oxidic and non-oxidic groups. The oxidic fibers mainly consist of aluminum oxide. SiO₂ or ZrO₂ are used as additives. Silicon carbide is the basic material of non-oxidic fibers. The additives are oxygen, titanium, zirconium and aluminum. While the e-module of oxide fibers is between 150 GPa and 370 GPa, the e-module of non-oxide fibers is between 180 GPa and 420 GPa. The tensile strength of oxide fibers is between 1.7 and 3.5 GPa, whereas it is between 2.5 GPa and 4.0 GPa for non-oxide fibers. Although ceramic fibers are stable up to 1600° C., they are very expensive. In addition, they are not used at temperatures lower than 1000° C. when there is a low thermal and mechanical stress. Further, these fibers shall be regarded as harmful to health and are included in the candidate list to be included in Annex XIV (substances requiring authorization) of the EU Chemicals Regulation REACH (Regulation: Registration, Evaluation, Authorization and Restriction of Chemicals).

### Basalt Fibers

Basalt fibers consist of thin fibers of basalt rocks. Basalt fibers are made of a liquid molten basalt mass at approximately 1400 (+/−50)° C. Their components are SiO₂, Al₂O₃, CaO, MgO and other oxides. Basalt fibers have a good chemical stability and a tensile strength of 3.7 GPa at a module of 90-110 GPa. The thermal stability is approx. 700° C. The price of these fibers lies between 2.5 and 4€/kg.

### Quartz Fibers

Quartz fibers consist of 99.99% amorphous SiO₂. They are more temperature-resistant and acid-resistant than silicate fibers. They have a tensile strength of 3.2-3.6 GPa and an e-module of 76-78 GPa. Their price (800€ per kg) is significantly higher than the price of silicate fibers. The permanent temperature stability is approx. 1200° C.

Fiber types are usually chosen and/or produced as a function of the desired temperature stability, wherein e-glass fibers are typically chosen for temperatures of up to 600° C.; beyond that, ECR glass fibers are chosen for temperatures of up to 550° C. and silicate fibers for temperatures of up to 1000° C. and ceramic fibers are chosen beyond this range for temperatures of up to 1600° C.

### Disadvantages in the State of the Art

However, the mentioned fiber types have diverse disadvantages. Said disadvantages can arise from the general environmental properties of the fibers, from the circumstances of processing or from economic aspects.

Ceramic fibers are crystalline and therefore not biodegradable and hence potentially harmful to health, if not outright carcinogenic.

Silicate fibers and/or quartz fibers can be produced through melt-spinning. In this method, every single filament needs a flawless bar of ultra-clean SiO₂, which does not have any bubbles or crystal centers, etc. The individual bars have to be heated directly. For this reason, the process is extremely expensive and complex. These fibers are only used for radome and optical light transmission.

In the process of dry-spinning of silicate fibers/sol gel, harmful tetraethyl-orthosilicate, TEOS, is used. In addition, a poly-condensation has to run in a controlled way. The method is complex and very expensive due to the chemicals used. The price is clearly above 10€/kg. The obtained fibers have average mechanical properties.

Silicate fibers from leaching procedures are obtained from glass fiber precursors. The glass fibers have a SiO₂weight percentage between 52% and 70% at the beginning, and at the end of the process their SiO₂ percentage is higher than 93%. The fibers lose a large part of their original firmness (from 3.4 GPa to approx. 0.35 GPa) and the price is very high (over 10€/kg) in proportion to their properties.

### SUMMARY OF THE INVENTION

In view of the problems in the state of the art discussed above, the purpose of this invention is to provide, as an alternative to the explained fibers, a fiber product and a method for the production of said fiber product whose thermal stability is adjustable between 700-1000° C. while having better mechanical properties than comparable fiber products available on the market. In this context, a simpler manufacturing process should be enabled and described disadvantages from the existing state of the art should be reduced to a minimum. Furthermore, also the manufacturing prices of such insulation products should be reduced significantly.

The invention provides a surface-modified glass fiber; the surface-modified glass fiber comprising: a core made of a first glass fiber material; a surface layer that fully encloses the core in a sheath-like way, wherein the surface layer has a higher silicon dioxide percentage and a higher porosity compared to the core.

In this context, the first glass fiber material of the core can comprise E-glass, water glass or A-glass.

The core can have a silicon dioxide percentage of approx. 52%.

The surface layer can have a silicon dioxide percentage of 96% as a maximum.

The core can thereby have a core diameter of at least 0.5 μm and the surface layer can also have a thickness of at least 0.5 μm.

The invention provides a method for producing a surface-modified glass fiber structure, wherein the glass fiber structure is a precursor fiber or a non-woven fiber layer made of needled precursor fibers, wherein the glass fiber structure consists of a first glass fiber material that comprises E-glass, water glass or A-glass, comprising the following steps: leaching of the glass fiber structure through treatment with, in particular dipping into, a predefined acid solution for a predetermined time at a predetermined ambient temperature and for a predefined acid concentration.

It is clear that the surface-modified glass fiber structure is derived from the untreated glass fiber structure, i.e. a precursor fiber or a non-woven fiber layer, by means of the method. Hence, the precursor fiber and/or the non-woven fiber layer made of needled precursor fibers are each the source elements for the method.

The source elements for the method, the precursor fiber or the non-woven fiber layer/non-woven fiber pad made of precursor fibers are mostly treated equally as part of the method so that the description of the following steps applies both to a precursor fiber as well as to a plurality of precursor fibers that have already been needled to a non-woven fiber layer in advance. Commercially available fibers, for example the widespread and cost-efficient E-glass fibers can be used as precursor fiber and/or precursor fibers, but also the rarer water glass or A-glass fibers. As part of the method, the surface of the precursor fiber, i.e. of the source fiber and/or of the precursor fibers of the non-woven fiber layer is modified through incomplete leaching. The surface layer, in short the surface, of the surface-modified fiber obtained by means of the method consists in large parts of silicon dioxide SiO₂. The incomplete leaching process, however, leaves the core or the inner area of the precursor fiber unchanged so that said core consists essentially of the unleached/untreated original source material, i.e. for example of unmodified E-glass fiber material or unchanged water glass or A-glass fiber material. The surface-modified fiber formed this way can also be referred to as two-component fiber or bi-component fiber, wherein the core is the first, inner component and the modified, sheath-like surface layer, which encloses the core completely, is the second, outer component.

The core of the fibers is not leached in the method described above. The resulting surface-modified glass fibers therefore have better mechanical properties. Further, the core of the fibers remains compact without leaching, and it will not become porous. There will consequently be a significant limitation of shrinking in case of temperature exposure of the resulting bi-component fiber.

Conversely, the modified surface layer that encloses the core completely and that can also be referred to as sheath layer or sheath is strongly leached compared to the core. The percentage of SiO₂ will be significant in this layer. The modified surface layer becomes porous due to leaching. These pores of the modified surface layer can only be closed under the impact of thermal stress and therefore ensure thermal protection for the core.

A further advantage of the surface-modified glass fibers is that the glass transition temperature for these fibers is increased in relation to the source material because oxides with a lower thermal resistance are removed from the sheath layer during leaching. This means that specific oxides, which reduce the thermal stability or the glass transition temperature of the fiber, can therefore be removed from the sheath layer. Examples are B₂O₃, CaO, MgO, K₂O, Na₂O, and others.

In the method, the predefined acid solution can comprise an aqueous solution of formic acid or hydrochloric acid or sulphuric acid.

Generally, acids to which SiO₂ is chemically resistant can be used for leaching, for example also oxalic acid, nitric acid, phosphoric acid, acetic acid. Leaching according to the desired degree of leaching consequently increases the SiO₂ percentage to a value of 52% up to approximately 96%.

The parameters of the method can be adjusted to the desired fiber type of the source material and the desired degree of leaching. In particular, the temperature of the acid solution for the method can be between ambient temperature and 100° C. Even higher temperatures can also be achieved by means of reflux. In that case, water would evaporate and condense again. Concentration gradients of H₂SO₄ would take place in a leaching tank. In this context, the reaction time for leaching, i.e. the predetermined time can amount to 3 min to 3 h in the method. Likewise, the acid concentration of the acid solution in the method can be between 0.5 molar and 6 molar, in particular between 1 molar and 3 molar.

In addition, leaching of rolled goods in the needled compound structure is possible without using a coating. In particular for a non-woven fiber material, it is further advantageous that not individual fibers are leached before being compounded to a non-woven fiber material, but that directly the non-woven fiber material, which can already come close to the desired end product in form and manufacturing conditions prior to leaching, is leached.

Likewise, a method for producing a non-woven fiber composite structure is provided, comprising: production of a first non-woven fiber layer as described above and application of a second non-woven fiber layer consisting of a second glass fiber material on the first non-woven fiber layer, wherein the second glass fiber material comprises E-glass, water glass or A-glass.

Hence, at least a partially treated non-woven fiber composite structure of at least two non-woven fiber layers/non-woven material pad is formed. Of these two, one non-woven fiber layers was leached before while the other one is untreated.

Further, the method for producing a non-woven fiber composite structure can comprise: application of a third non-woven fiber layer on the first non-woven fiber layer in such a way that the second non-woven fiber layer and the third non-woven fiber layer enclose the first non-woven fiber layer in a sandwich-like way, wherein the third non-woven fiber layer is identical to the second non-woven fiber layer.

This leads to savings in manufacturing steps during production of high-temperature non-woven fibers. The non-woven fiber composite structure can have a structure consisting of a core and a sheath layer while being either formed in a sandwich-like way of for example three layers—bi-component non-woven fiber layer/non-woven material pad made of a commercially available fiber/bi-component non-woven fiber layer—or only equipped with bi-component fibers up to half the thickness, respectively through systematic leaching.

### BRIEF DESCRIPTION OF THE DRAWINGS

FIG. 1 Schematic illustration of the surface-modified fiber

FIG. 2 Leached surface-modified E-glass fibers and schematic illustration of a surface-modified fiber from FIG. 1.

FIG. 3 Schematic view of a non-woven fiber composite structure with surface-modified fibers in a sandwich structure.

FIG. 4 Schematic view of a non-woven fiber composite structure with surface-modified fibers.

### DETAILED DESCRIPTION OF THE INVENTION

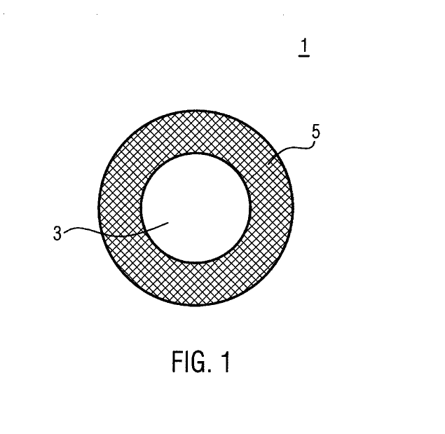

FIG. 1 shows a schematic illustration of a surface-modified fiber 1 according to the present invention. Based on a precursor glass fiber structure, here a glass fiber, for example an E-glass fiber or a water glass fiber or an A-glass fiber, a surface-modified fiber 1 was formed by means of incomplete leaching. In this context, the surface-modified fiber 1 comprises two components, i.e. a modified surface layer 5 and an essentially—in relation to the untreated, non-leached source fiber—unchanged core 3. Also an incomplete leaching of the fibers is performed in this process. A leaching gradient between the surface layer of the fibers 5, which are strongly leached, and their core 3, which is not leached, can hereby be achieved.

For the purpose of leaching, the glass fibers are treated with an acid solution, i.e. usually dipped into said solution. Formic acid, hydrochloric acid or sulphuric acid can be used respectively in an aqueous solution for this purpose.

The precursor glass fibers are dipped into the chosen acid solution in a defined way. The temperature of the acid solution can thereby be set appropriately between ambient temperature and 100° C. Further, the reaction time in this process can be varied between 3 minutes and 3 hours. Based on temperature, acid type, acid concentration, for example between 1 molar and 3 molar, and reaction time, the intensity of the leaching process is controlled. The goal of the leaching process, as already indicated, is to achieve a silicon dioxide gradient between the core and the sheath layer. The maximum gradient between the core and the sheath layer can have a maximum amount of 42%+−3% as the base fiber has a SiO₂ percentage of 52% and the fiber, which was leached at a maximum, has a SiO₂ percentage of approx. 96%.

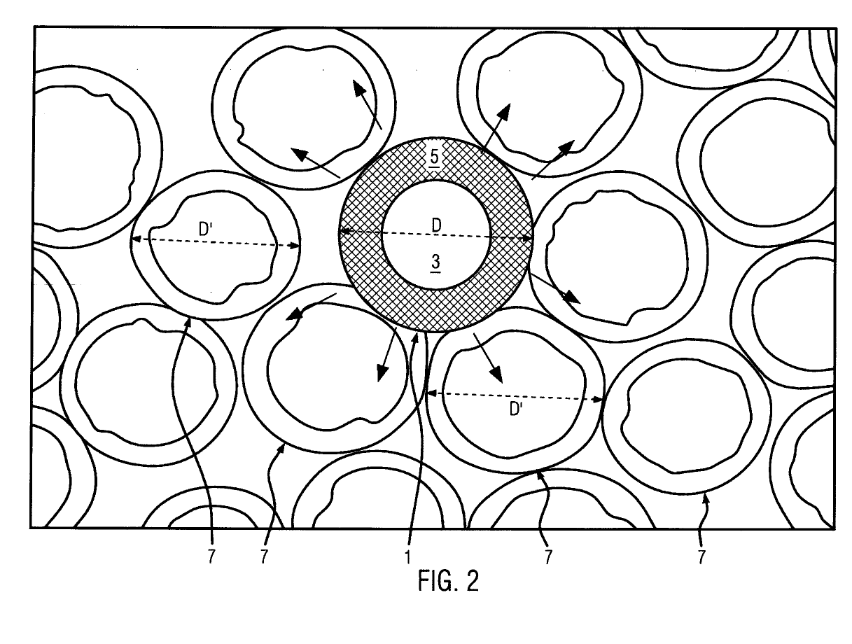

FIG. 2 illustrates an example of a core-sheath structure of fibers according to the present invention. FIG. 2 illustrates a plurality of E-glass fibers that have been exposed to an incomplete, i.e. partial, leaching process, i.e. that have been dipped into an acid solution in a defined way. Typical values are for example a temperature of 50° C., a three-molar H₂SO₄ over a period of 24 hours. The E-glass fibers are denominated with the reference sign 7. Differences between the individual treated fibers 7 are not considered here. Hence, the individual treated fibers 7 shall be regarded as equal on average. The individual treated, i.e. surface-modified, fibers 7 have an average diameter D′ of 9 μm. For explanation, in the middle of the Figure in FIG. 2, the fiber 1 sketched in FIG. 1 is included in addition with its core 3 and its sheath layer 5. The fiber 1 has a diameter D that corresponds to the average diameter D′ of the photographically displayed treated fibers 7. The distinction between the two components of the treated fibers, i.e. of the core and the respective sheath layer, i.e. the area in which leaching of the source material has taken place, can be seen clearly in the photographic illustration of the fibers 7.

The sheath layer 5 has an elevated silicon percentage and at the same time a higher porosity while the core 3 maintains the original properties of the precursor fibers 1. In this context, the core 3 is characterized by a compact and non-porous structure. The porosity of the fiber behaves equivalently to its weight loss due to leaching.

Hence, the porosity of the fiber is equivalent to the loss of mass of the leached oxides.

The core 3 thereby has—as before—the superior mechanical properties of the source fiber, for example E-module, tensile strength, etc. In this context, the source material, i.e. the precursor fiber as well as the core 3, which is not modified during treatment of the fiber, can definitely have a low thermal stability. However, the core 3 is protected by the sheath layer 7. This sheath layer 7 has a higher temperature stability due to the treatment. Consequently, also the overall modified fiber structure 1 has a higher temperature resistance than the core 3, i.e. also the source fiber. The thermal resistance and the mechanical properties depend on the proportion between the sheath thickness and the diameter of the core.

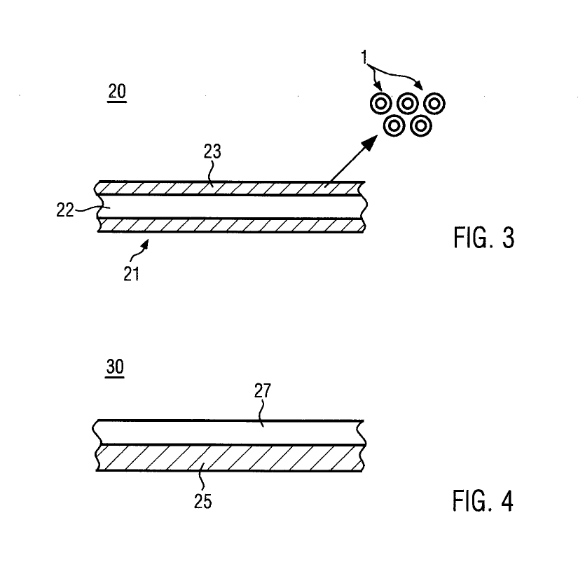

This core-sheath structure can also be extended to non-woven fiber composite structures as illustrated in FIGS. 3 and 4. As already indicated, the treatment of non-woven fiber layers takes place in a similar way as the treatment of individual fibers. In this process, the individual fibers are at first needled to the non-woven fiber layer/non-woven material pad before the overall non-woven fiber layer is subsequently dipped into a defined acid solution at defined treatment parameters.

FIG. 3 shows a sandwich structure 20 with a first temperature-stable outer non-woven fiber layer made of treated bi-component fibers 21 and a second temperature-stable outer non-woven fiber layer made of treated bi-component fibers 23. Typically, the two non-woven fiber layers 21 and 23 are equal and are formed each of equal treated bi-component fibers as they are illustrated based on FIGS. 1 and 2. In an enlarged view, which only exists for explanatory purposes, fibers 1, which have already been discussed based on FIGS. 1 and 2, are displayed next to one another on the right side of FIG. 3 to indicate a non-woven material pad. Accordingly, the non-woven fiber layer 23 and also the non-woven fiber layer 21 from FIG. 3 can correspond to a non-woven material pad made of fibers 1. In the structure that is sketched exemplarily in FIG. 3, the two non-woven fiber layers 21 and 23 directly enclose a further non-woven fiber layer 22 that, however, only comprises untreated fibers, i.e. only one component. The inner layer 22 consists for example essentially of untreated E-glass. This inner layer 22 can for example have a temperature stability of 600 to 700° C. as a maximum. On the other hand, the two non-woven fiber layers 21 and 23, which respectively consist of the treated bi-component fibers, have a higher temperature stability that the inner layer 22. Said temperature stability can typically be 700-1000° C. Hence, a higher temperature stability can be provided through the outer layers 21 and 23 of the sandwich structure shown in FIG. 3. At the same time, the structure keeps the good mechanical firmness properties of the fibers of the inner layer 22. The thicknesses of the layers 21 and 23 can be chosen based on the leaching duration and the untreated fiber diameter. They can typically be identical. It is clear that it is equally possible to provide the inner layer 22 with a thickness that differs significantly from the thickness of the outer layers.

There are frequent applications in the insulation area, in which the temperature stress essentially occurs on only one side of an insulation structure. In case of such a “one-sided” temperature stress it is equally possible, as shown in FIG. 4, to equip only half of the non-woven material product, i.e. of the insulation structure, with a temperature stability of 700-1000° C. while leaving the rest untreated. FIG. 4 shows an insulation structure/non-woven material product 30 that comprises two layers. It is a non-woven fiber layer 25 of treated fibers and an untreated non-woven fiber layer 27 that differs from said non-woven fiber layer. Similar to FIG. 3, the bi-component non-woven fiber layer 25 is formed of treated bi-component fibers as they are explained on the basis of FIGS. 1 and 2. In this context, the non-woven fiber layer 25 typically also corresponds to the non-woven fiber layers 21 and 23 from FIG. 3. Hence, the non-woven fiber layer 25 can have a temperature stability of 700-1000° C. As displayed in FIG. 4, a non-woven fiber layer 27 is disposed above the non-woven fiber layer 25 in a way that is similar to a sandwich structure from FIG. 3 that is cut in a longitudinal direction. The non-woven fiber layer 27 can have the same temperature properties as the non-woven fiber layer 22 from FIG. 3. It is therefore clear that the side of the structure 30, which comprises the treated bi-component non-woven fiber layer 25, is arranged to face an object to be insulated whereas the side of the structure 30, which has the non-woven fiber layer 27 made of untreated fibers, is arranged to face away from an object to be insulated.

The surface-modified fibers and/or non-woven fiber layers provided by the invention are particularly suitable for heat insulation in the high-temperature range from approximately 700° C. to 1000° C., depending on the application intensity, wherein defined tensile forces and defined elasticity modules are required or a generally higher firmness and/or stability of the fiber products. Potential uses can be seen in the high-temperature area, in particular in the field of the automotive industry, the aviation and space industry, in flow engineering as well as specific requirements in the field of thermo-acoustic systems. Common diesel applications in the automotive industry are in the temperature range of 800-900° C. ECR glass fibers with a temperature resistance of 750° C. are under-dimensioned for this application case and silicate fibers with a temperature resistance of 1000° C. are over-dimensioned and too expensive. Here, the product described in the invention offers an optimal solution. In addition, it comes with the advantage of being able to provide highly temperature-stable fibers and products without the need to be at the same time manufacturer of fibers, in particular glass fibers.

What is claimed is:

1. A surface-modified glass fiber, comprising:
a core of a first glass fiber material;
a surface layer that completely surrounds the core in a sheath-like way; and
wherein the surface layer has a higher silicon dioxide percentage and a higher porosity compared to the core.

2. The surface-modified glass fiber according to claim 1, wherein the first glass fiber material of the core comprises E-glass, water glass or A-glass.

3. The surface-modified glass fiber according to claim 1, wherein the core has a silicon dioxide percentage of at least 52%.

4. The surface-modified glass fiber according to claim 1, wherein the surface layer has a silicon dioxide percentage of 96% as a maximum.

5. The surface-modified glass fiber according to claim 1, wherein the core has a core diameter of at least 0.5 μm and wherein the surface layer also has a thickness of at least 0.5 μm.

6. A non-woven fiber composite structure, comprising:
a first non-woven fiber layer made of surface-modified glass fibers according to claim 1;
a second non-woven fiber layer made of a second glass fiber material;
wherein the second non-woven fiber material is layered over the first non-woven fiber layer;
wherein the second glass fiber material comprises E-glass, water glass or A-glass.

7. The non-woven fiber composite structure according to claim 6, further comprising:
a third non-woven fiber layer, wherein the third non-woven fiber layer is equal to the second non-woven fiber layer; wherein the second and the third non-woven fiber layer enclose the first non-woven fiber layer in a sandwich-like way.

8. A method for producing a surface-modified glass fiber structure, wherein the glass fiber structure is a precursor fiber or a non-woven fiber layer made of needled precursor fibers, wherein the glass fiber structure is made of a first glass fiber material that comprises E-glass, water glass or A-glass, comprising the following steps:
leaching of the glass fiber structure through treatment with a predetermined acid solution for a predetermined time at a predetermined ambient temperature and at a predetermined acid concentration.

9. The method according to claim 8, wherein the predetermined acid solution comprises an aqueous solution of formic acid or hydrochloric acid or sulphuric acid.

10. The method according to claim 8, wherein the temperature of the predetermined acid solution is between ambient temperature and 100° C.

11. The method according to claim 8, wherein the predetermined time is between 3 minutes and 3 hours.

12. The method according to claim 8, wherein the acid concentration of the acid solution is between 1 molar and 3 molar.

13. The method for producing a non-woven fiber composite structure, comprising
production of a first non-woven fiber layer according to claim 8; and application of a second non-woven fiber layer made of a second glass fiber material onto the first non-woven fiber layer, wherein the second glass fiber material comprises E-glass, water glass or A-glass.

14. The method for manufacturing a non-woven fiber composite structure according to claim 13, further comprising:
the application of a third non-woven fiber layer onto the first non-woven fiber layer in such a way that the second non-woven fiber layer and the third non-woven fiber layer enclose the first non-woven fiber layer in a sandwich-like way, wherein the third non-woven fiber layer is equal to the second non-woven fiber layer.

15. A surface-modified glass fiber manufactured by means of the method according to claim 8.

16. The method according to claim 8, wherein:
the treatment with the predetermined acid solution comprises dipping.

17. A surface-modified glass fiber having a bi-component structure comprising:
a core having a first porosity, first silicon dioxide content, and first thermal resistance;
a sheath surrounding said core, said sheath having a second porosity, second silicon dioxide content, and second thermal resistance; and
wherein the second porosity is greater than the first porosity, the second silicon dioxide content is greater than the first silicon dioxide content, and the second thermal resistance is greater than the first thermal resistance,
whereby insulation made of the surface-modified glass fiber is capable of being manufactured with higher temperature stability than the core of the surface-modified glass fiber.
